(19) United States
(12) Patent Application Publication
(10) Pub. No.: US 2013/0168185 A1
(43) Pub. Date: Jul. 4, 2013

(54) Movable Lift

(71) Applicants: Wen-Hsiu HUANG, Chiayi City (TW); Chu-Ho CHEN, Chiayi City (TW)

(72) Inventors: Wen-Hsiu HUANG, Chiayi City (TW); Chu-Ho CHEN, Chiayi City (TW)

(21) Appl. No.: 13/342,139

(22) Filed: Jan. 2, 2012

(51) Int. Cl. B66F 11/04; E04G 1/24; E04G 1/22

(52) U.S. Cl. 182/14

(57) ABSTRACT

A movable lift in accordance with the present invention has a frame with a connecting base, a telescoping tube mounted on the connecting base, a driving tool attached to the telescoping tube, and an elevating device mounted on the frame to drive a pallet. By having the above structure, the movable lift is operated by a user on the pallet to move, rotate the movable lift, or elevate the pallet even when the pallet is lifted high. Therefore, the movable lift is easy and convenient in operation and utility.

### BACKGROUND OF THE INVENTION

1. Field of the Invention

The present invention relates to a movable lift, and more particularly to a movable lift which is operated by a user on a pallet to move or rotate the movable lift, or elevate the pallet even when the pallet is lifted high.

2. Description of Related Art

A conventional constructional lift setting a predict height for high work is provided to make engineers to detach billboard or paint at high location, or to assemble color fluorescent tubes or to repair alarm devices. However, the conventional constructional lift is not movable and must to set wheels thereunder to allow users to push or pull to move. Therefore, the conventional constructional lift is usually operated by two workers, one is on the pallet lifted highly and the other stands beside the conventional constructional lift to push. If the conventional constructional lift is operated by one worker only, the worker has to climb up and down frequently to perform the work and to drive the conventional constructional lift separately.

### SUMMARY OF THE INVENTION

A main objective of the present invention is to provide a movable lift which can be operated conveniently.

To achieve the foregoing objective, the movable lift comprises:

a frame having a pedestal and a pallet movably mounted the pedestal, and multiple wheels attached under the pedestal;

a connecting base mounted on the frame and having a top, a bottom, a socket formed on the top, a non-circular hole defined on the socket, and a transmission device contained inside the connecting base to connect to a ground wheel;

a telescoping tube mounted to the connecting base and comprising a driving rod with a non-circular cross-section which has an upper end and lower end respectively defined as a driving distal and a driving portion, wherein the driving portion inserts into the non-circular hole of the socket for combination;

an elevating device mounted on the frame beside the pallet and comprising an oil-pressure box with a pedal attached to the oil-pressure box, a rotation rod attached to a top of the oil-pressure box, a knob secured on the rotation rod for release pressure of the oil-pressure box, an oil-pressure driving rod communicated with the oil-pressure box by a resilient tube, and an oil-pressure driving lower rod telescoping with the oil-pressure driving rod and secured to the pedestal of the frame, wherein the pedal has a pivot portion attached to a second resilient element mounted under the oil-pressure box; and

a driving tool mounted on the telescoping tube, electrically connected to a motor, and having a driving end inserting to the driving distal of the driving rod, a handle formed at side of the driving tool to rotate the driving rod to control rotation of the ground wheel, wherein the handle has a switch set at underside of the handle to actuate or stop the motor and a direction switch set as side face of the handle to switch rotational directions of the motor to control the forward or backward of the movable lift; and

a Y-shaped bracket is mounted at a top side of the telescoping tube to hold the handle.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a movable lift in accordance with the present invention;

FIG. 2 is a perspective view of the movable lift in FIG. 1, wherein a pallet is lowered;

FIG. 3 is an operational perspective view of the movable lift in FIG. 1, wherein a pallet is lifted by driving a pedal;

FIG. 4 is an operational perspective view of the movable lift in FIG. 1, wherein a pallet is lowered by driving a rotating knob;

FIG. 5 is a partially enlarged perspective view of one side of a connecting base of the movable lift;

FIG. 6 is a partially enlarged perspective view of the other side of the connecting base of the movable lift;

FIG. 7 is a cross-sectional side view of one side of the connecting base engaged between a ground wheel and a telescoping tube of the movable lift;

FIG. 8 is a cross-sectional side view of the other side of the connecting base engaged between the ground wheel and the telescoping tube of the movable lift;

FIG. 9 is a cross-sectional front view of the connecting base, the ground wheel, and the telescoping tube in FIG. 8 combined with a driving tool;

FIG. 10 is a cross-sectional front view of the connecting base and the wheel which is not locked; and

FIG. 11 is a cross-sectional front view of the connecting base and the wheel which is not lock.

### DETAILED DESCRIPTION OF THE PREFERRED EMBODIMENT

A movable lift in accordance with the present invention has a frame with a connecting base, a telescoping tube mounted on the connecting base, a driving tool attached to the telescoping tube, and an elevating device mounted on the frame to drive a pallet. By having the above structure, the movable lift is operated by a user on the pallet to move, rotate the movable lift, or elevate the pallet even when the pallet is lifted high. Therefore, the movable lift is easy and convenient in operation and utility.

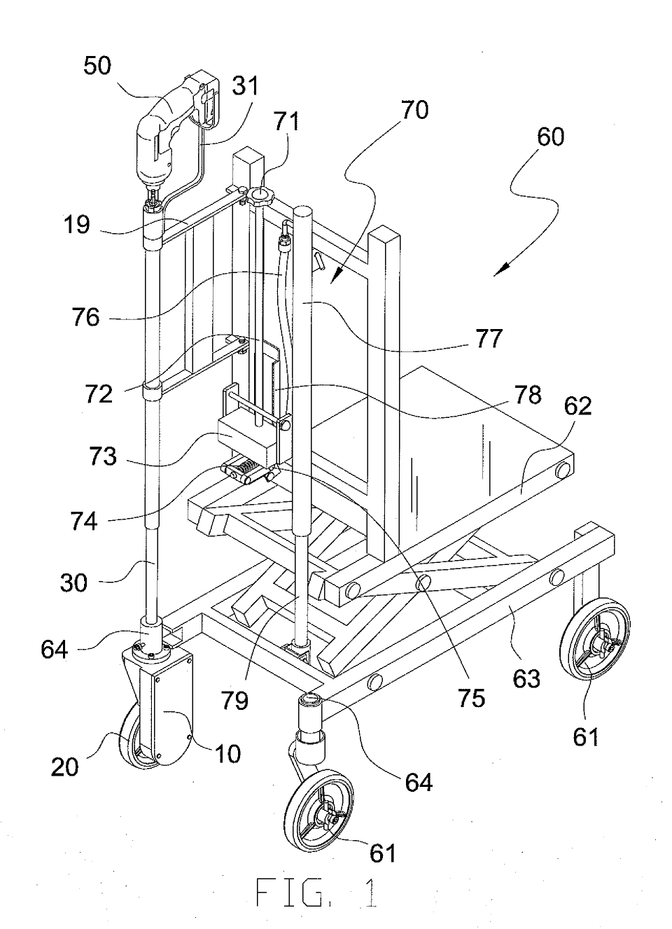

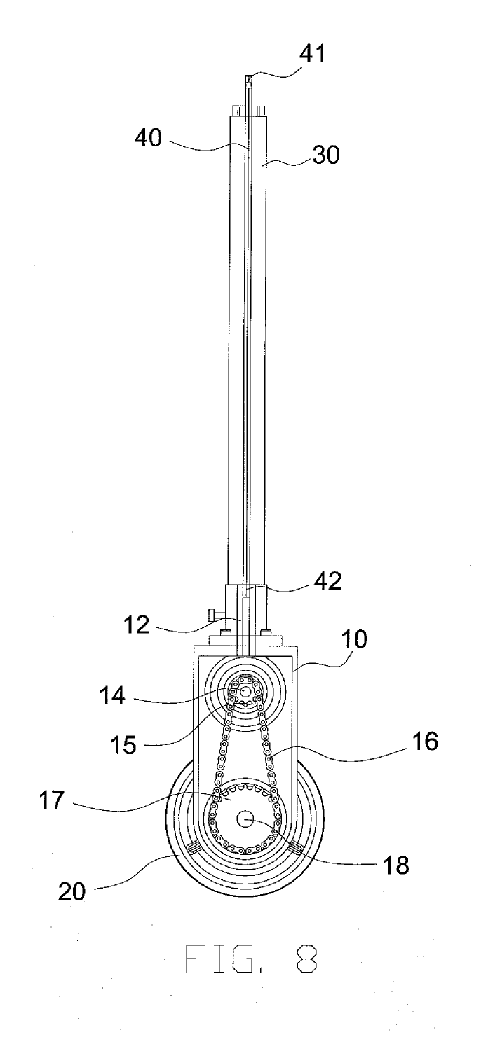

As shown in FIGS. 1 to 11, a preferred embodiment of a movable lift in accordance with the present invention comprises a frame 60 with a connecting base 10, a telescoping tube 30, a driving tool 50, and an elevating device 70.

The frame 60 has a pedestal 63 and a pallet 62 movably mounted the pedestal 63 up and down. Multiple wheels 61 are attached under the pedestal 63 and two joint portions 64 are formed at a rear end of the pedestal 63.

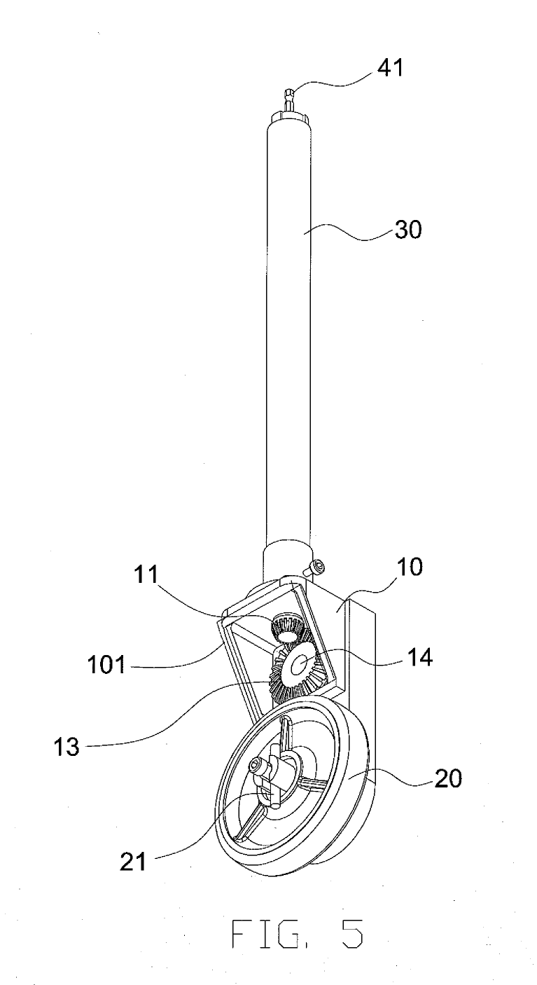

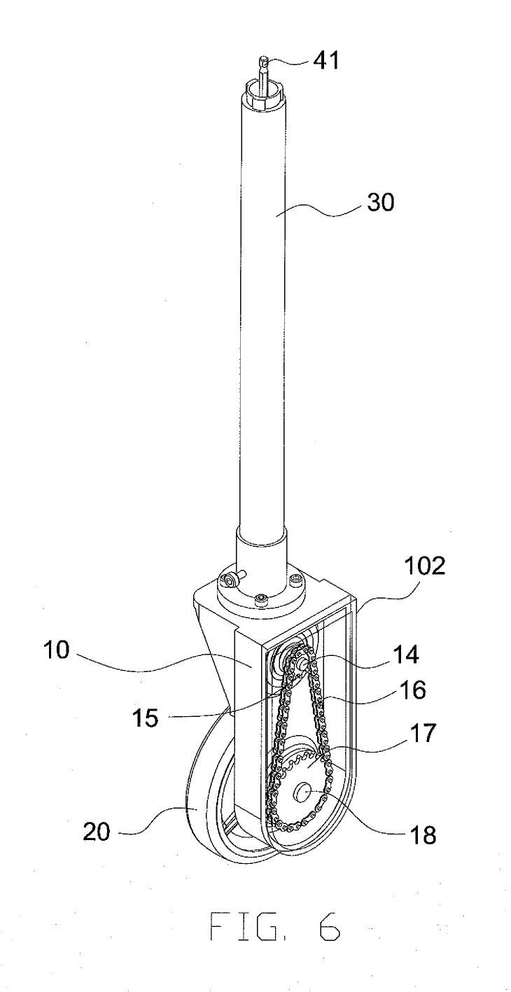

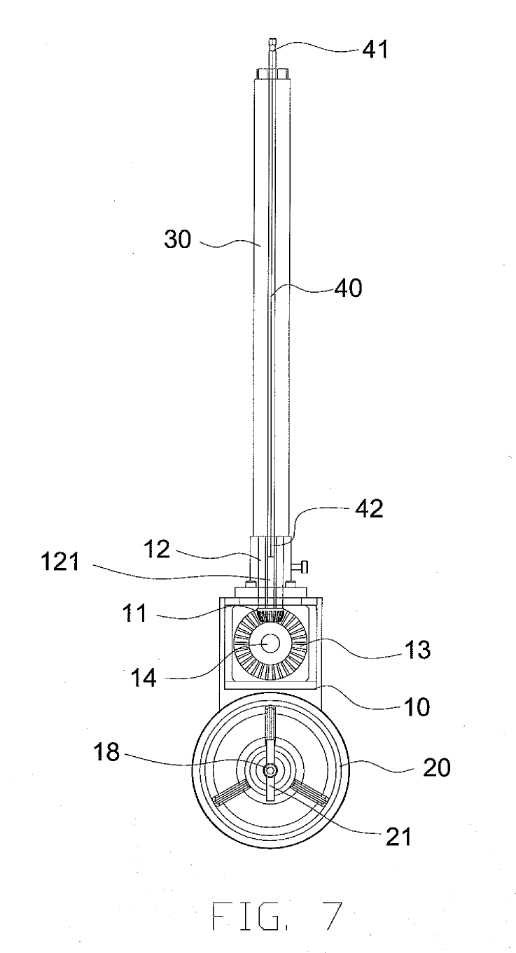

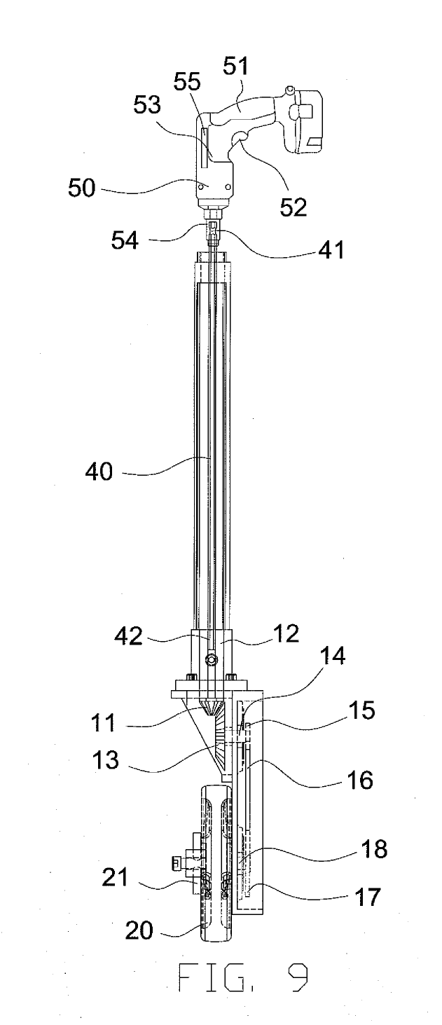

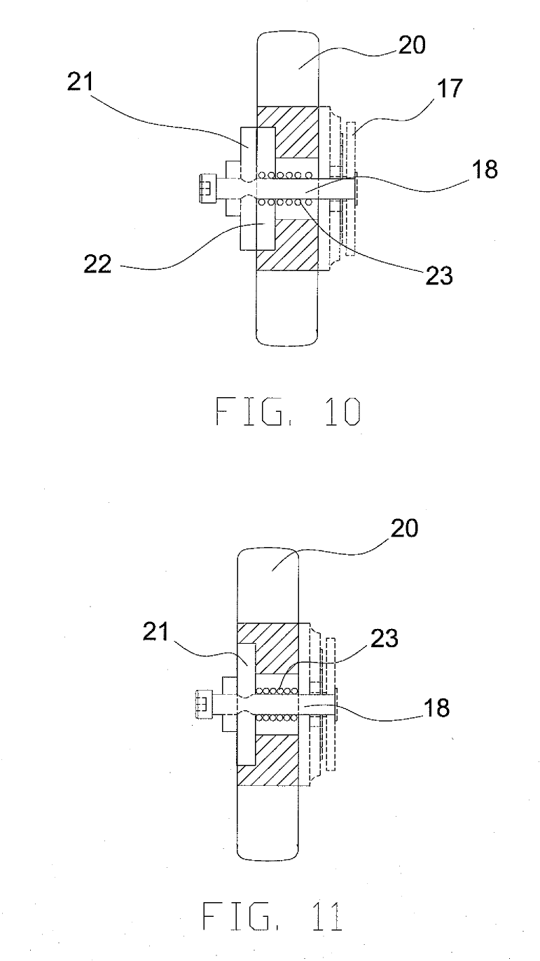

The connecting base 10 is a case selectively mounted on one of the two joint portions 64 of the frame 60 to satisfy a right-handed or left-handed user. As shown in FIGS. 7-9, the connecting base 10 has a top, a bottom, a socket 12 formed on the top and a non-circular hole 121 defined on a top of the socket 12. A transmission device is contained inside the connecting base 10 to connect to a ground wheel 20 and comprises the following elements. A first tapered gear 11 is attached to the bottom of the connecting base 10 and a second tapered gear 13 vertically engaged with the first tapered gear 11 and having a driving shaft 14 at the center of the second tapered gear 13 to combine with a first chain wheel 15. A second chain wheel 17 is attached on the connecting base 10 below the first chain wheel 15 and looped with the first chain wheel 15 by a chain 16. The second chain wheel 17 further has a central shaft 18 extending to connect to the ground wheel 20 so that the ground wheel 20 is driven by movement of the tapered gears 11, 13 (as shown in FIG. 9). With further reference to FIGS. 10 and 11, the ground wheel 20 has a break portion 21 mounted on a distal end of the central shaft 18 and further has a recess 22 defined on side to receive the break portion 21. A resilient element 23 surrounds the central shaft 18 and is clamped between the break portion 21 and the second chain wheel 17. When the break portion 21 is pushed inward to press the resilient element 23 and then engages with the recess 22, the ground wheel 20 is locked and ceased to move. Furthermore, the connecting base 10 has an outer cover 102 (shown in FIG. 6) and side lid 101 (shown in FIG. 5) to cover the elements inside the connecting base 10.

The telescoping tube 30 is mounted to the connecting base 10 selectively combined to one of the two joint portions 64 on the frame 60 and comprises a long driving rod 40 (as shown in FIG. 7) with a non-circular cross-section which has an upper end and lower end respectively defined as a driving distal 41 and a driving portion 42. The driving portion 42 inserts into the non-circular hole 121 of the socket 12 for combination. Additionally, a Y-shaped bracket 31 (see FIG. 1) is mounted at a top side of the telescoping tube 30.

With reference back to FIG. 1, the elevating device 70 is mounted on the frame 60 beside the pallet 62 to allow a user operate it on the pallet 62 and comprises an oil-pressure box 73 with a pedal 78 attached at side. The pedal 78 has a pivot portion 75 attached to a second resilient element 74 mounted under the oil-pressure box 73 so that the restitution force is provided by the second resilient element 74 to the pedal 78. A rotation rod 72 is attached to a top of the oil-pressure box 73 and has a knob 71 secured on a distal of the rotation rod 72 for release pressure of the oil-pressure box 73. The oil-pressure box 73 is communicated to an oil-pressure driving rod 77 by a resilient tube 76 and the oil-pressure driving rod 77 telescopes an oil-pressure driving lower rod 79 which is secured to the pedestal 63 of the frame 60.

With reference to FIG. 9, the driving tool 50 has a driving end 54 inserting to the driving distal 41 of the driving rod 40. When the driving end 54 engages the driving distal 41, the driving tool 50 is rested on the Y-shaped bracket 31 of the telescoping tube 30 and electrically connected to a motor 53. The driving tool 50 further has a handle 51 at side to control rotation of the ground wheel 20. The handle 51 has a switch 52 set at underside of the handle 51 to actuate or stop the motor 53 and has a direction switch 55 set at right side or lift side to switch rotational directions of the motor 53 to control the forward or backward of the movable lift.

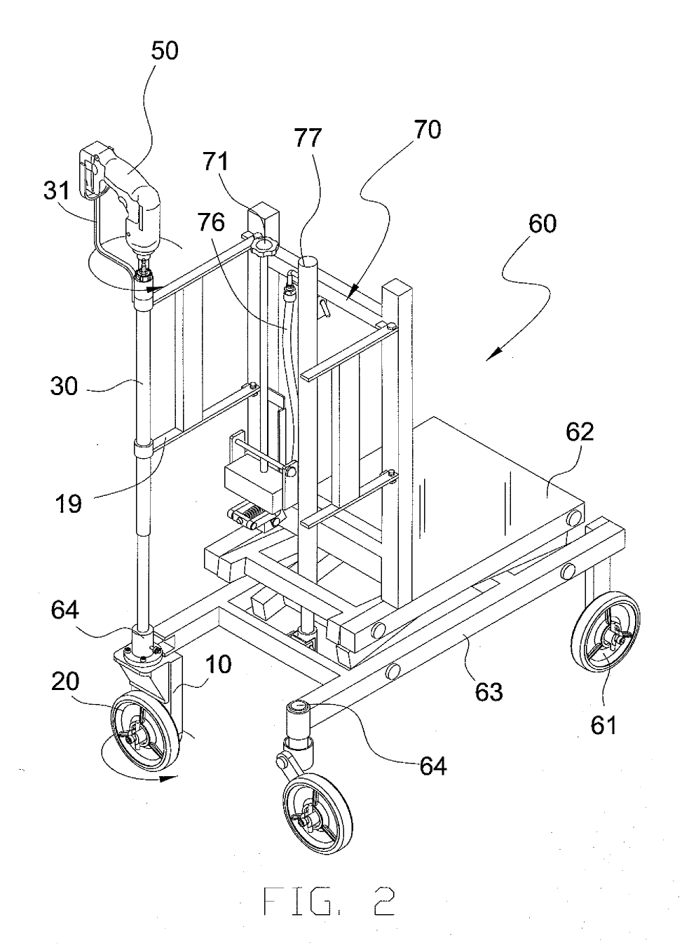

Therefore, a user can grip the handle 51 and press the switch 52 of the driving tool 50 to actuate the motor 53 to drive the driving end 54, the driving rod 40, the first tapered gear 11, the second tapered gear 13, the first chain wheel 15, the second chain wheel 17 to make the ground wheel 20 rotate. Moreover, the telescoping tube 30 and the driving rod 40 have a predict height aligned with the pallet 62 to allow the user to operate the ground wheel 20 and drive the movable lift to move by a connecting bridge 19. As shown in FIG. 2, when the user wants to change the moving direction of the movable lift, the user rotates the handle 51 of the driving tool 50 and then the grounds wheel 20 is rotated to change the direction. When the user wants to move backward, the user presses the direction switch 55 to make the motor 53 in a reverse mode for driving the movable lift to move backward.

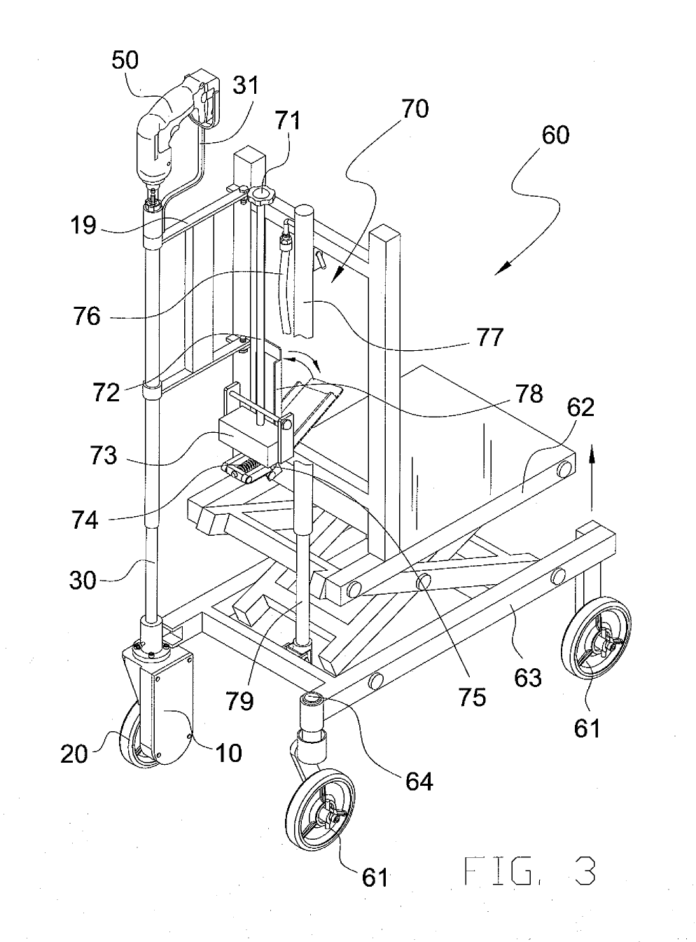

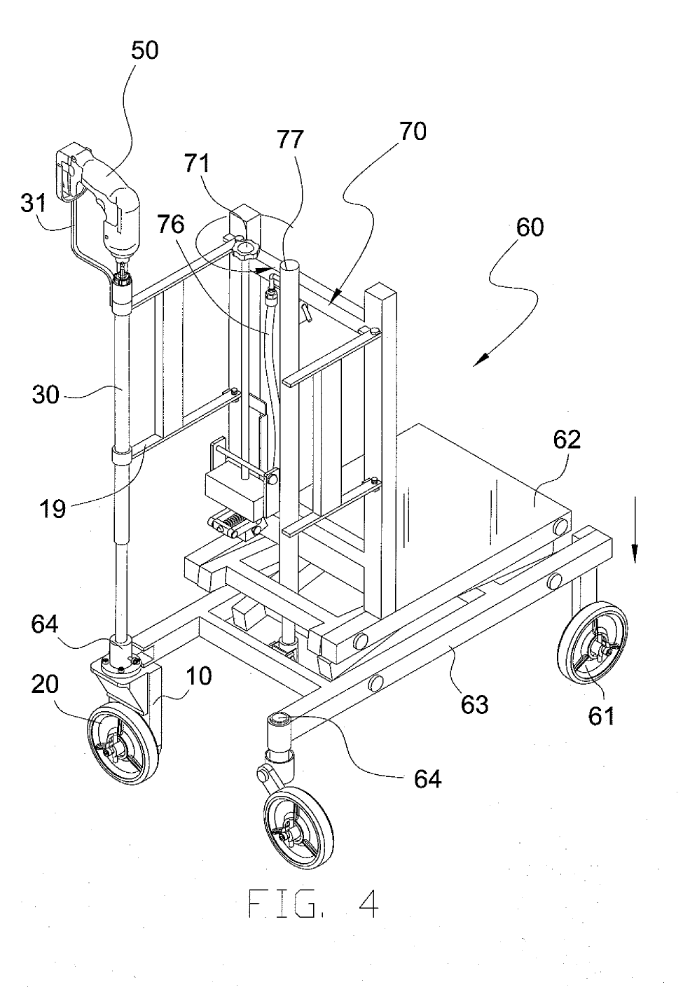

With reference to FIGS. 3 and 4, when the user wants to elevate the pallet 62, the users steps the pedal 78 to make the oil-pressure box 73 to pump the oil-pressure driving rod 77 and to drive the oil-pressure driving lower rod 79 to extend out downward so that the pallet 62 is driven upward and lifted. On the contrary, when the user wants to lower the pallet 62, the user rotates the knob 71 to drive the rotation rod 72 to release the pressure of the oil-pressure box 73. Meanwhile, the oil-pressure driving lower rod 79 is retracted into the oil-pressure driving rod 77 to make the pallet 62 lowered.

According to above description, the movable lift in accordance with the present invention has simple structure and is easy in operation to allow the user on the pallet 62 to drive the ground wheel 20 to move the frame 60 with wheels 61 forward, backward or rotate even when the pallet 62 is lifted at high position. The movable lift is applicable in any high work above the ground such as billboard attachment, fire-fighting system setting, etc. and is easy to be composed or disassembled. Moreover, the movable lift of the present invention has durable and low-malfunctioning quality and thus improves its working efficiency, convenience and utility.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A movable lift comprising:
a frame having a pedestal and a pallet movably mounted the pedestal, and multiple wheels attached under the pedestal, wherein the frame has two joint portions are formed at a rear end of the pedestal to engage with the connecting base;
a connecting base mounted on the frame and having a top, a bottom, a socket formed on the top, a non-circular hole defined on the socket, and a transmission device contained inside the connecting base to connect to a ground wheel, wherein the transmission device comprises
a first tapered gear attached to the bottom of the connecting base;
a second tapered gear vertically engaged with the first tapered gear and having a driving shaft;
a first chain wheel mounted on the driving shaft;
a second chain wheel attached on the connecting base below the first chain wheel and having a central shaft to secure the ground wheel; and
a chain looping the first chain wheel and the second chain wheel;
a telescoping tube mounted to the connecting base and comprising a driving rod with a non-circular cross-section which has an upper end and lower end respectively defined as a driving distal and a driving portion, wherein the driving portion inserts into the non-circular hole of the socket for combination;
an elevating device mounted on the frame beside the pallet and comprising an oil-pressure box with a pedal attached to the oil-pressure box, a rotation rod attached to a top of the oil-pressure box, a knob secured on the rotation rod for release pressure of the oil-pressure box, an oil-pressure driving rod communicated with the oil-pressure box by a resilient tube, and an oil-pressure driving lower rod telescoping with the oil-pressure driving rod and secured to the pedestal of the frame, wherein the pedal has a pivot portion attached to a second resilient element mounted under the oil-pressure box;
a driving tool mounted on the telescoping tube, electrically connected to a motor, and having a driving end inserting to the driving distal of the driving rod, a handle formed at side of the driving tool to rotate the driving rod to control rotation of the ground wheel, wherein the handle has a switch set at underside of the handle to actuate or stop the motor and a direction switch set as side face of the handle to switch rotational directions of the motor to control the forward or backward of the movable lift; and
a Y-shaped bracket is mounted at a top side of the telescoping tube to hold the handle.

2. The movable lift as claimed in claim 1, wherein the ground wheel comprises
a break portion mounted on a distal end of the central shaft;
a recess defined on side of the ground wheel to receive the break portion; and
a resilient element surrounding the central shaft and clamped between the break portion and the second chain wheel.
